(19) United States
(12) Patent Application Publication
(10) Pub. No.: US 2025/0370195 A1
(43) Pub. Date: Dec. 4, 2025

(54) MPO CONNECTOR WITH NON-MT MULTI-FIBER FERRULE AND SLEEVE THEREFOR

(71) Applicant: US Conec Ltd., Hickory, NC (US)

(72) Inventors: Jason Higley, Hickory, NC (US); Darrell R. Childers, Hickory, NC (US)

(21) Appl. No.: 18/874,755

(22) PCT Filed: Jul. 20, 2023
(86) PCT No.: PCT/US2023/070612

§ 371 Date: Dec. 13, 2024

Related U.S. Application Data
(60) Provisional application No. 63/390,953, filed on Jul. 20, 2022.
(60) Provisional application No. 63/393,739, filed on Jul. 29, 2022.

(51) Int. Cl. G02B 6/38

(52) U.S. Cl. CPC G02B 6/3885; G02B 6/3821; G02B 6/3869; G02B 6/3874

(57) ABSTRACT

A fiber optic connector for fiber optic ferrule has an outer housing, an inner housing at least partially disposed within the outer housing, an inner sleeve positioned within the inner housing and engageable with a rear facing surface inside the inner housing, the ferrule engaged by a rearward facing surface of the inner sleeve, and a spring positioned rearward of and exerting a force on a rear end of the inner sleeve to bias the ferrule and the inner sleeve in a forward direction, wherein the combination of the inner sleeve and the ferrule is in a floating configuration inside the connector.

### REFERENCE TO RELATED CASE

This application claims priority under 35 U.S.C. § 119(e) to U.S. provisional application Nos. 63/390,953 filed on Jul. 20, 2022 and 63/393,739 filed Jul. 29, 2022, the contents of which are hereby incorporated by reference in their entirety.

### BACKGROUND OF THE INVENTION

Conventional MPO fiber optic connectors support the standard MT multi- fiber fiber optic ferrule in an inner housing. One such MPO connector is the MTP® PRO brand connector by the Applicant. This MPO connector also has an outer housing or outer sleeve to aid removal from and insertion into an adapter or a receptacle. Sometimes, the combination of the inner housing and the outer sleeve is also jointly referred to in the industry simply as a “housing” or an “MPO housing.” As is known to person of ordinary skill in the art, the conventional MPO connector housing can only support an MT ferrule with at least three optical fibers terminated therein (typically 8-16) as a row of optical fibers, although two or more rows are also available. The fibers in the MT ferrule are typically separated at a 250 μm pitch at an end face of the MT ferrule.

Recent advances in data center technology have prompted a need for a higher density of optical interconnects. To address this challenge, Applicant has introduced what has now come to be known in the industry as the TMT fiber-optic ferrule. The newer TMT ferrule is a significantly smaller multi-fiber ferrule compared to the standard MT ferrule. FIGS. 1 and 2 show an example of the relative dimensions of the two multi-fiber ferrules—the MT 10 and the TMT 20, respectively. Typical dimensions for the larger MT ferrule are 3.0 mm height, 8.05 mm length between the front end and the rear end, and 7 mm width. In comparison, the dimensions for the TMT ferrule are 1.25 mm height, 4 mm length (between the front end and the rear end), and a width of 6.4 mm. That is, the TMT ferrule has a much smaller footprint than the MT ferrule. More details on the TMT ferrule are provided in Applicant's International Patent Application Number PCT/US2021/028919 (Published as WO 2021/217050, hereinafter “the '050 publication” and is incorporated herein by reference), titled “Miniature Multi-Fiber Ferrule.” One example difference between the TMT ferrule and the MT ferrule is the lack of any projecting shoulder in the TMT ferrule. Instead, the TMT ferrule has cutouts 22, 24 in the body of the ferrule. See again, FIG. 2. The pitch between the optical fibers in the TMT ferrule is still 250 μm, for backward compatibility. Applicant has also provided the disclosure of an example non-MPO format connector housing in the '050 publication that seats the TMT ferrule (see, e.g., FIG. 8 of the '050 publication). The optical interconnect industry is beginning to see a shift in the trend towards the usage of the TMT ferrule instead of the MT ferrule for various reasons, the smaller size of the TMT ferrule being one big reason.

Certain other types of smaller MT-like ferrules are also being introduced in the market. One such smaller ferrule is being promoted by Senko Advanced Components of Massachusetts. This smaller ferrule is designed for an SN®-MT brand connector also promoted by Senko Advanced Components. Likewise, FSG Networks Limited of Japan provides a smaller MT-like ferrule. Each of these types of multi-fiber ferrules includes optical fiber support structures (as does the novel TMT ferrule) inside to secure the optical fibers for termination therein. While these two smaller ferrules look like smaller versions of the standard MT ferrule, no conventional MPO connector can accommodate these other two non-standard MT-like ferrules.

As this shift to smaller footprints is happening, there is also a need for using the TMT ferrule for mating with MT ferrule and/or MPO connectors with MT ferrules. Additionally, Applicant has also identified a need for having the TMT ferrule being used inside legacy MPO housings, which currently cannot support the TMT ferrule by itself.

In yet another field application where the MT ferrule is utilized is for pre-populated adapter assemblies with MPO housings. In these applications, the terminated MT ferrule with the optical fiber ribbon is provided with a ferrule push inside a pulling grip of an optical cable bundle. The terminated MT ferrule along with the ferrule push is pulled out of the pulling grip at the edge of a data center, and the ferrule push is used to simply push the terminated MT ferrule into the adapters pre-populated with the MPO housing. This scenario is described, for example, in Applicant's U.S. Pat. No. 11,280,966 (hereinafter “the '966 patent” and is incorporated herein by reference in its entirety).

Again, as the adoption of the TMT ferrule continuously increases, in the scenario described in the '966 patent, Applicant has identified that the MT ferrule is replaceable with the TMT ferrule, without necessarily making any changes to the ferrule push currently in use.

Applicant therefore provides a way in which to use the TMT ferrule in the MPO housing without requiring a wholesale reconstruction of the MPO housing.

### SUMMARY OF THE INVENTION

According to one aspect, the present invention is directed to a multi-fiber fiber optic connector for a multi-fiber fiber optic ferrule having at least one terminated row of optical fibers, comprising an outer housing, an inner housing at least partially disposed within the outer housing, an inner sleeve having a main body and a shoulder at a rear portion of the main body, the inner sleeve at least partially positioned within the inner housing and engageable with a rear facing surface inside the inner housing and having a central opening, the multi-fiber fiber optic ferrule having optical fiber support structures to hold optical fibers of the at least one terminated row of optical fibers, the multi-fiber fiber optic ferrule engaged by a rearward facing surface of the inner sleeve, and a spring positioned rearward of and exerting a force on a rear end of the inner sleeve to bias the multi-fiber fiber optic ferrule and the inner sleeve in a forward direction, wherein the combination of the inner sleeve and the multi-fiber fiber optic ferrule is in a floating configuration inside the multi-fiber fiber optic connector.

In some embodiments, the multi-fiber fiber optic connector is an MPO connector and the multi-fiber fiber optic ferrule is a TMT ferrule.

In some embodiments, there may be a sleeve shoulder formed on the main body to engage an inner housing of a multi-fiber fiber optic connector.

In some embodiments, there may be at least one centering element to support a spring to bias the sleeve in a forward direction toward the multi-fiber fiber optic ferrule.

In some embodiments, there may be a sleeve slot formed on one side of the main body extending longitudinally between the rear portion and the middle portion to allow the insertion of the at least one terminated optical fiber ribbon into the central opening.

In some embodiments, there may also be a top extension and a bottom extension in a front portion of the main body and extending away from both a middle portion and a rear portion, each of the top extension and the bottom extension having a rear facing surface at a free end to engage the multi-fiber fiber optic ferrule.

In another aspect, the present invention is directed to sleeve for receiving a multi-fiber fiber optic ferrule, the sleeve includes a main body having a front portion, a middle portion, and a rear portion, a top extension and a bottom extension in the front portion and extending away from both the middle portion and the rear portion, each of the top extension and the bottom extension having a rear facing surface at a free end to engage the multi-fiber fiber optic ferrule, a central opening extending longitudinally between a rear end of the rear portion and a front end of the middle portion and being in communication with a space between the top extension and the bottom extension, the central opening configured to receive at least two optical fibers, a pair of guide pin bores on opposing sides of the central opening and also extending longitudinally between the rear end of the rear portion to the front end of the middle portion, a sleeve shoulder formed on the main body to engage an inner housing of a multi-fiber fiber optic connector; and wherein the middle portion includes at least one ferrule seat between the top extension and the bottom extension adjacent the central opening to seat the multi-fiber fiber optic ferrule.

In some embodiments, there may also be at least one centering element to support a spring to bias the sleeve in a forward direction toward the multi-fiber fiber optic ferrule.

In some embodiments, there may also be a sleeve slot formed on one side of the main body extending longitudinally between the rear portion and the middle portion to allow the insertion of the at least two optical fibers into the central opening.

In some embodiments, the main body has at the rear end of the rear portion at least one receptacle to receive at least one projection from a pin clamp disposed behind the multi-fiber fiber optic ferrule.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a front perspective view of an MT ferrule;

FIG. 2 is a front perspective view of a TMT ferrule;

FIG. 3 is a perspective view of one embodiment of an MPO connector with an inner sleeve according to the present invention;

FIG. 4 is a perspective view of the MPO connector in FIG. 3 with the inner housing sectioned to reveal one embodiment of an inner sleeve according to the present invention;

FIG. 5 is a perspective view of a cross section of the MPO connector in FIG. 3;

FIG. 6 is a perspective view the internal components of the MPO connector in FIG. 3 with the inner housing and outer housing removed showing the TMT ferrule, the sleeve, a pin clamp; and optical fibers in a ribbon format;

FIG. 7 is a bottom perspective view of the internal components of the MPO connector in FIG. 6;

FIG. 8 is a top rear perspective view of the internal components of the MPO connector in FIG. 6;

FIG. 9 is a perspective view of the internal components of the MPO connector in FIG. 6 with the inner sleeve in cross section;

FIG. 10 is a front perspective view of the inner sleeve in FIG. 9;

FIG. 11 is a perspective view of the inner sleeve in FIG. 9;

FIG. 12 is rear elevational view of the inner sleeve in FIG. 9;

FIG. 13 is a rear perspective of another embodiment of an inner sleeve according to the present invention;

FIG. 14 is a front perspective of another embodiment of an inner sleeve according to the present invention;

FIG. 15 is a perspective view of another embodiment of a two-piece inner sleeve, ferrule, pin clamp, and optical fibers according to the present invention;

FIG. 16 is an exploded view of the two-piece inner sleeve in FIG. 15;

FIG. 17 is a front perspective view of an inner housing of an MPO connector with projections on an inner surface;

FIG. 18 is a perspective view of a cross section of the inner housing of FIG. 17 and the other parts of the MPO connector;

FIG. 19 is a perspective view from the top of the MPO connector of FIG. 18 with the inner housing in cross section;

FIG. 20 is a front perspective view of another embodiment of an MPO connector and a different ferrule with an inner sleeve according to the present invention;

FIG. 21 is an exploded view of the MPO connector in FIG. 20 with the spring removed for clarity;

FIG. 22 a perspective view of a cross section of the MPO connector in FIG. 20;

FIG. 23 is a perspective view from the top of a cross section of the MPO connector of FIG. 20;

FIG. 24 is a perspective view of the internal components of the MPO connector of FIG. 20;

FIG. 25 is a front perspective view of the sleeve in FIG. 20; and

FIG. 26 is a perspective view of a cross section of the sleeve of FIG. 25.

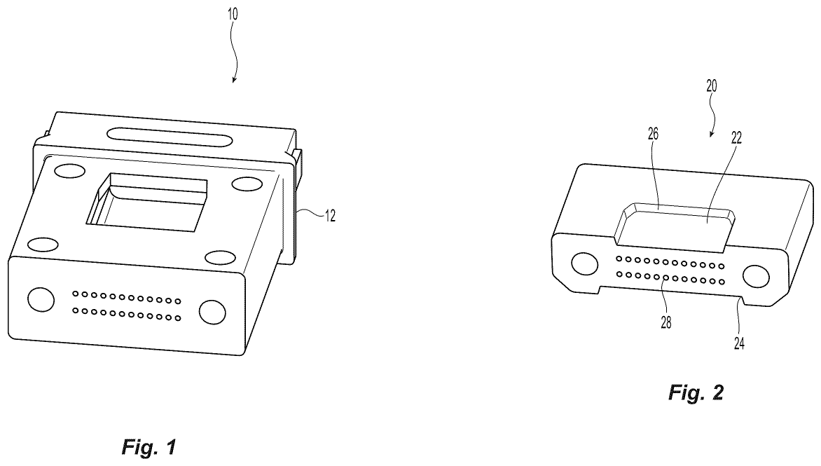

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

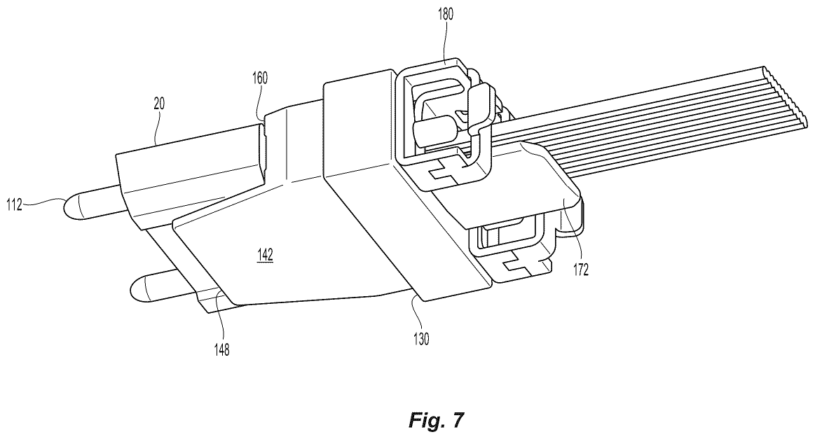

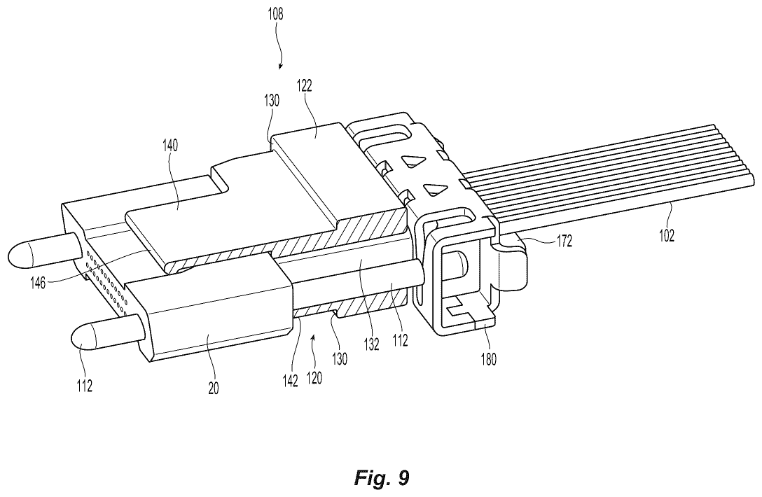

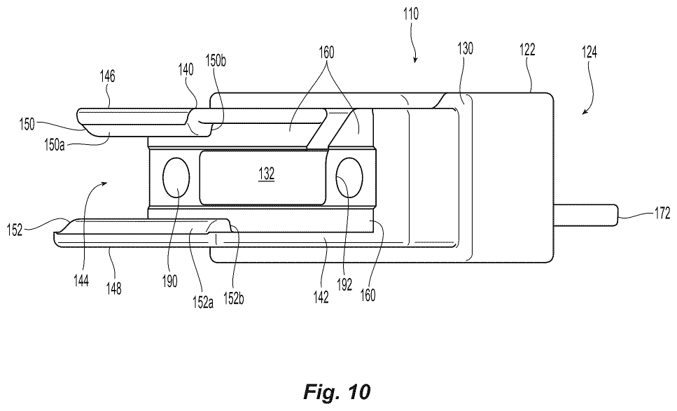

FIGS. 3-5 illustrate an multi-fiber fiber optic connector 100 (connector) with at least one terminated optical fiber ribbon 102 and an outer housing 104, an inner housing 106 at least partially disposed within the outer housing 104, an inner sleeve 108 (interchangeably also referred to as “sleeve 108”), and a multi-fiber fiber optic ferrule 20 (ferrule 20). Again, the ferrule 20 is smaller than the standard MT 10. The optical fibers that constitute the optical fiber ribbon 102 are terminated within the ferrule 20 as is known within the art. It will be appreciated by one of ordinary skill in the art after reading this disclosure that although an optical fiber ribbon 102 is shown, loose fibers in a bundle may instead be provided (i.e., in an un-bonded arrangement). The ferrule 20 has support structures 28 to hold optical fibers of the at least one terminated fiber-optic ribbon 102. The ferrule 20 then has at least one terminated row of optical fibers whether the optical fiber ribbon 20 is used or loose fibers are used. In one embodiment, the support structures 28 may be micro-holes or v-grooves. There may be other configurations to support the optical fibers that constitute the optical fiber ribbon 102. As illustrated herein, the connector 100 is an MPO connector and the ferrule is a TMT ferrule, but the principles disclosed herein may also be applicable to other multi-fiber fiber optic connectors and multi-fiber fiber optic ferrules smaller than the standard MT 10. There may also be a spring 110 that is positioned rearward of and exerting a force on a rear end of the Inner sleeve 108 to bias the multi-fiber fiber optic ferrule 20 and the inner sleeve 108 in a forward direction. The ferrule 20 may also have guide pins 112 to assist with the mating of multiple connectors 100. FIGS. 6-9 illustrate a connector 100 with the outer housing 104 and the inner housing 106 removed for clarity. FIGS. 10-13 show one embodiment of the inner sleeve 108 according to the present invention by itself.

Applicant notes that the term “front” or “forward” as used herein means that direction where the connector 100 would meet with another connector or device or mating ferrules inside a receptacle, while the term “rear” or “rearward” is used to mean the direction from which the optical fibers enter into the ferrule 20 or the connector 100. Each of the components will therefore have a front and rear, and the two respective fronts or forward portions of opposing ferrules for example, would engage one another. Thus, for example, in FIG. 3, the “front” of the connector 100 is on the left side and “forward” is to the left and out of the page. “Rearward” or “rear” is that part of the connector 100 that is on the right side of the page and “rearward” and “backward” is toward the right and into the page.

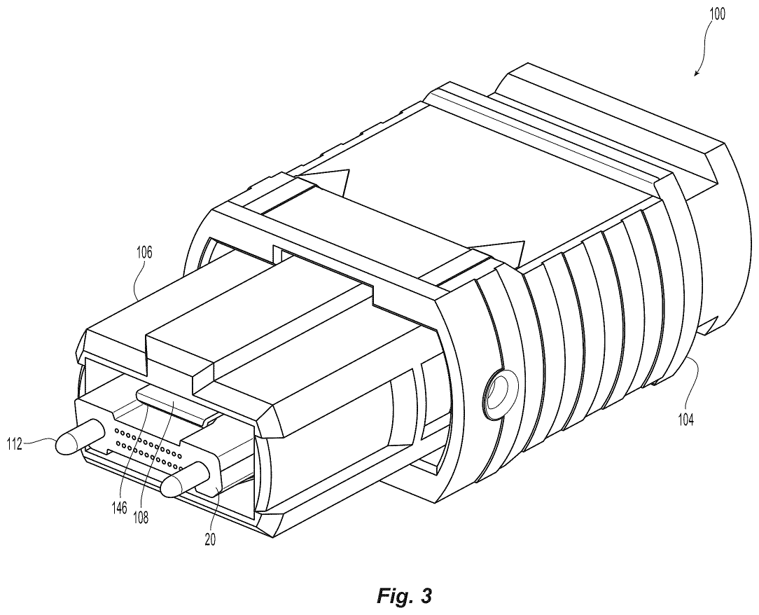

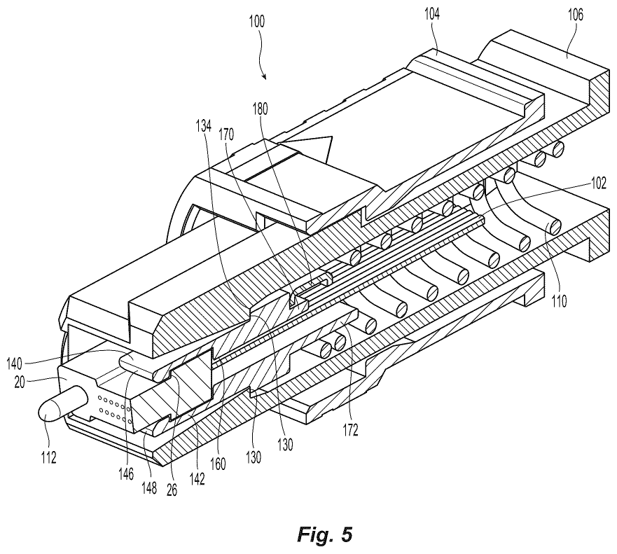

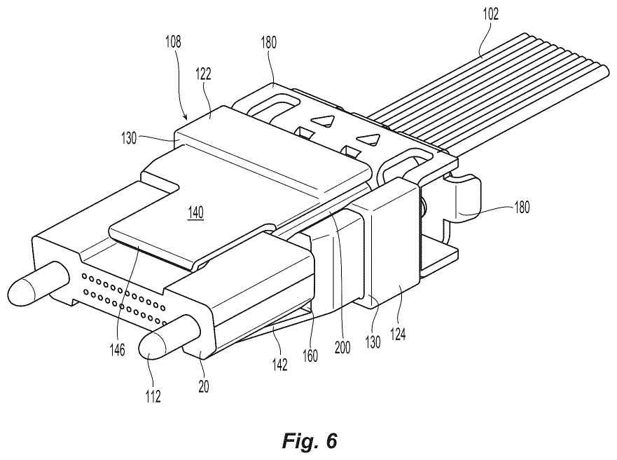

The inner sleeve 108 has a main body 120 and a shoulder 122 at a rear portion 124 of the main body 120. See FIGS. 10-12. The main body 120 also has a front portion 126 and a middle portion 128. The middle portion 128 is therefore disposed between the front portion 126 and the rear portion 124. The main body 120 has a sleeve shoulder 130 between the middle portion 128 and the rear portion 124 for engaging the inner housing 106 as described below with reference to FIG. 5 in particular. The main body 120 has a central opening 132 that extends longitudinally from at least the rear portion 124 to the middle portion 128. The front portion 126 has two extensions, a top extension 140 and a bottom extension 142, that extend from the middle portion 128 and away from the rear portion 124. The top extension 140 and the bottom extension 142 form an opening 144 therebetween and is in communication with the central opening 132 and may even be considered to be a part thereof. At the distal, free ends 146,148 of the top extension 140 and the bottom extension 142 are projections 150, 152 to engage the ferrule 20. Projection 150 preferably has a ramped surface 150a, while projection 152 has a ramped surface 152a, and each of the ramp surfaces generally face away from the middle portion 128. The ramped surface 150a and the ramped surface 152a assist when inserting the ferrule 20 into the inner sleeve 108 by causing the top extension 140 and the bottom extension 142 to flex apart from each other, and allow for the entry of the ferrule 20 therebetween. The top extension 140 and the bottom extension 142 also preferably include rearward facing surfaces 150b,152b, respectively. The rearward facing surface 150b and the rearward facing surface 152b engage a forward facing surface 26 on the ferrule 20 to assist in keeping the ferrule 20 within the connector 100. See also FIGS. 2 and 5.

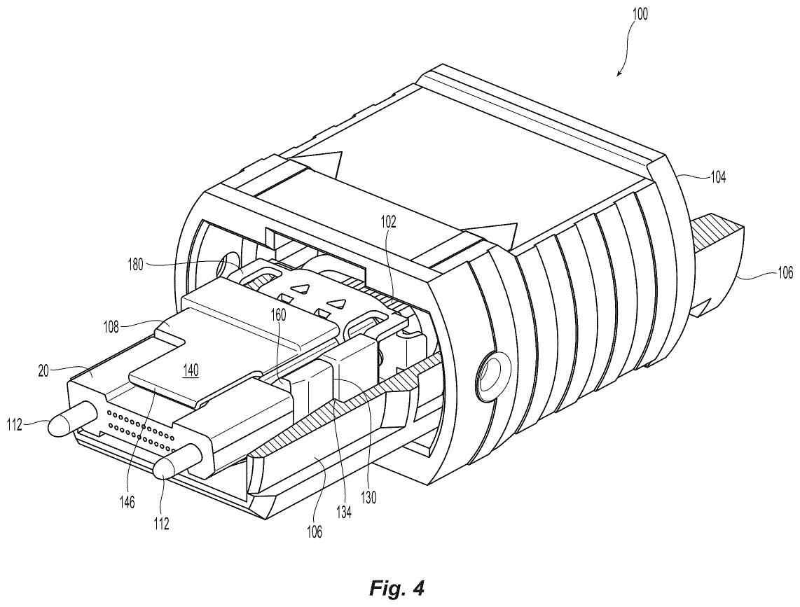

The inner sleeve 108 preferably includes at least one ferrule seat 160, the at least one ferrule seat 160 being disposed in the middle portion 128 of the main body 120. See FIGS. 4, 6, and 10, where there is a ferrule seat 160 on both the upper side and the lower side (by the top extension 140 and the bottom extension 142) of the main body 120. Thus, the ferrule seats 160 are adjacent to and on opposing sides of the central opening 132.

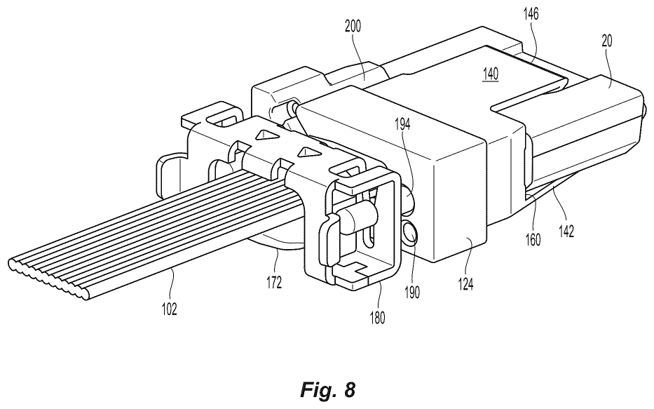

The inner sleeve 108 preferably includes at least one centering element and in this embodiment there are two centering elements, an upper centering element 170 and a lower centering element 172. The centering elements 170,172 are preferably attached to the rear portion 124 on opposite sides of the central opening 132 and extend rearwardly away from the main body 120. The centering elements 170,172 may be identical to one another, or as illustrated in the figures, one may be different than the other-length, width, etc. In this case, the lower centering element 172 is longer than the upper centering element 170 so that it extends beyond the pin clamp 180 (see, e.g., FIGS. 4 and 7). The centering elements 170,172 are used to center the spring 110 on the pin clamp 180 so that even pressure is provided to the pin clamp 180 and then to the ferrule 20. However, the upper centering element 170 may be omitted, but is useful if there is no pin clamp 180. Other configurations of the centering elements 170,172 are also possible (e.g., a ribbed or skeletal structure).

The inner sleeve 108 may also include guide pin holes 190,192 in the rear portion 124 that allow guide pins 112 to be inserted therethrough and into the pin clamp 180. The inner sleeve 108 may also have dimples 194,196 on the rear surface of the rear portion 124 that receive projections on a pin clamp 180 to better secure the pin clamp 180 to the inner sleeve 108. However, these may be omitted, particularly when no pin clamp 180 is used.

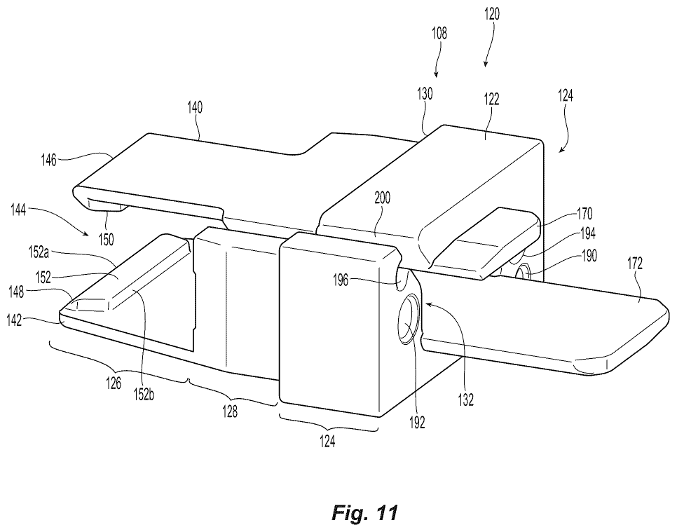

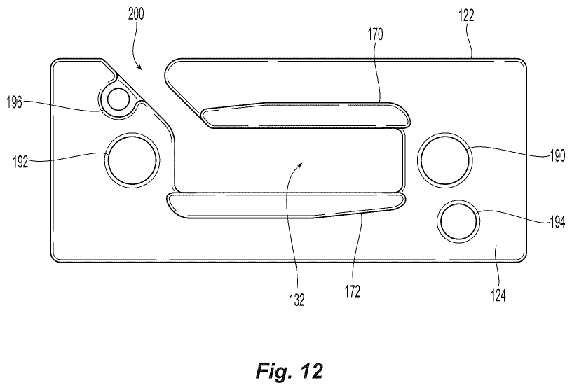

The inner sleeve 108 also includes a sleeve slot 200, which provides access from outside the inner sleeve 108 to the central opening 132. The sleeve slot 200 is illustrated as being adjacent to a top corner of the inner sleeve 108, which allows for the insertion of the optical fibers of the optical fiber ribbon 102 into the central opening 132. The sleeve slot 200 may be located elsewhere on the main body 120 and take a different shape as well. The sleeve slot 200 causes the top extension 140 to be asymmetric unlike the bottom extension 142. The sleeve slot 200 could be disposed in other places, if needed at all, so as not to interfere with the extensions 140,142. It should be noted that that sleeve slot 200 may also interfere with at least a portion of one of the dimples 194,196 on the rear surface of the rear portion 124. See, e.g., FIGS. 11 and 12. Another potential conflict is with the sleeve slot 200 and a portion of the upper centering element 170. The upper centering element 170 may have to be reduced so as not to interfere-see FIG. 12. The location of the dimples 194,196 or the projections on the pin clamp 180, could be relocated to allow for all of these features to be present at the same time.

Returning to FIG. 5, the inner sleeve 108 is at least partially positioned within the inner housing 106, and the sleeve shoulder 130 (facing forward in the connector 100) is engageable with a rear facing surface 134 inside the inner housing 106. It is also clear from FIG. 5, that the spring 110 is positioned rearward of and exerting a force on a rear end of the inner sleeve 108 to bias the ferrule 20 and the inner sleeve 108 in a forward direction. When there is a pin clamp 180 present in the connector 100, the force from the spring 110 is applied to the rear end of the inner sleeve 108 to bias the ferrule 20 through the pin clamp 180. With the spring 110 and the inner sleeve 108 so positioned, the combination of the inner sleeve 108 and the ferrule 20 is in a floating configuration inside the connector 100. The term “floating” as used herein refers to the ferrule 20 and the inner sleeve 108 engaging the inner housing 106 only at the forward facing surface 130 of the shoulder 122. A rear facing surface at the rear portion 124 thus has the same enclosed area or footprint as the standard MT 10 making the combination of the ferrule 20 and the inner sleeve 108 compatible with standard MPO housings. This also allows for use of the standard ferrule push for the standard MT 10 to be used with the combination of the ferrule 20 and the sleeve 108 inside a pulling grip, for insertion to pre-populated adapters with MPO housings attached thereto.

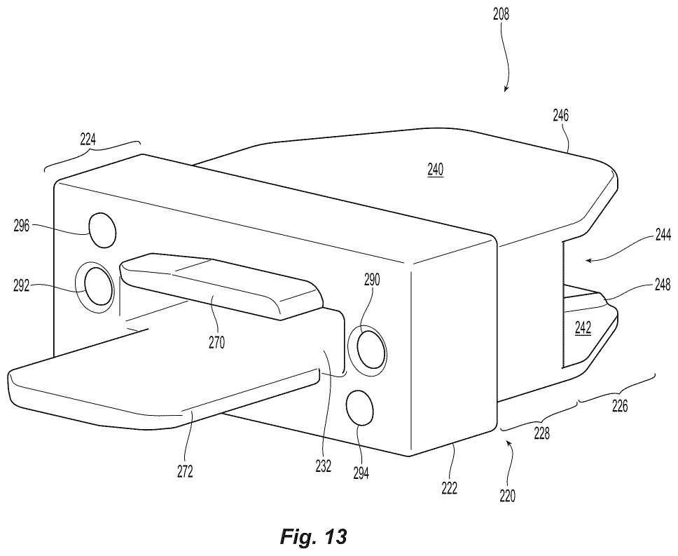

Another embodiment of an inner sleeve 208 according to the present invention is illustrated in FIG. 13. In this embodiment, there is no sleeve slot in the main body 220 as the optical fibers of the optical fiber ribbon 102 can be inserted into the inner sleeve 208 and the inner sleeve 208 inserted into a connector (connector 100 or other connectors as discussed above) with a ferrule 20. The remainder of the components are the same as with inner sleeve 108. To be complete, the following elements are visible in FIG. 13 and some of the elements discussed above, while not visible, are present-except for the sleeve slot.

The inner sleeve 208 has a main body 220 and a shoulder 222 at a rear portion 224 of the main body 220. The main body 220 also has a front portion 226 and a middle portion 228. The middle portion 228 is therefore disposed between the front portion 226 and the rear portion 224. The main body 220 has a sleeve shoulder 230 between the middle portion 228 and the rear portion 224 for engaging the rear facing surface 134 of the inner housing 106. The main body 220 has a central opening 232 that extends longitudinally from at least the rear portion 224 to the middle portion 228. The front portion 226 has two extensions, a top extension 240 and a bottom extension 242, that extend from the middle portion 228 and away from the rear portion 224. The top extension 240 and the bottom extension 242 form an opening 244 therebetween and it is in communication with the central opening 232 and may even be considered to be a part thereof. At the distal, free ends 246,248 of the top extension 240 and the bottom extension 242 are projections to engage the ferrule 20. The projections have a ramped surface and each of the ramp surfaces generally face away from the middle portion 228. The top extension 240 and the bottom extension 242 also preferably include rearward facing surfaces (not shown), respectively. The rearward facing surfaces engage a forward facing surface 26 on the ferrule 20 as in the prior embodiment.

The inner sleeve 208 preferably includes at least one centering element and in this embodiment there are two centering elements, an upper centering element 270 and a lower centering element 272. The centering elements 270,272 are preferably attached to the rear portion 224 on opposite sides of the central opening 232 and extend away from the main body 220. The centering elements 270,272 may be identical to one another, or as illustrated in the figures, one may be different than the other-length, width, etc. In this case, the lower centering element 272 is longer than the upper centering element 270 so that it extends beyond the pin clamp 180. The centering elements 270,272 are used to center the spring 110 on the pin clamp 180 so that even pressure is provided to the pin clamp 180 and then the ferrule 20. However, the upper centering element 270 may be omitted, but is useful if there is no pin clamp 180. Other configurations of the centering elements 270,272 are also possible.

The inner sleeve 208 may also include guide pin holes 290,292 in the rear portion 224 that allow guide pins 112 to be inserted therethrough and into the pin clamp 180. The inner sleeve 208 may also have dimples 294,296 on the rear surface of the rear portion 224 that receive projections on a pin clamp 180 to better secure the pin clamp 180 to the inner sleeve 108. However, these may be omitted, particularly when no pin clamp 180 is used. Without the sleeve slot, the dimples 294,296 are not interfered with and can be complete dimples.

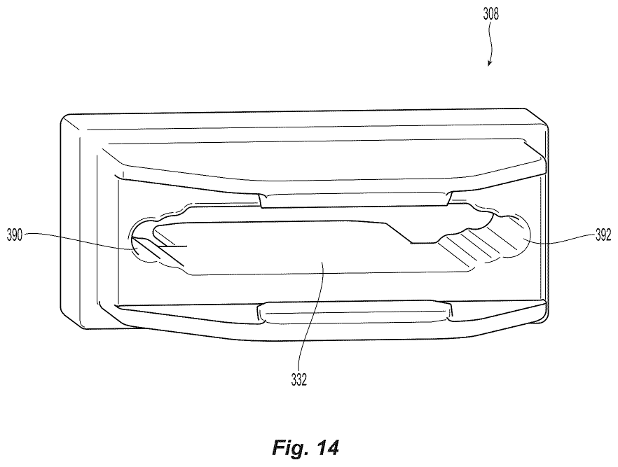

FIG. 14 illustrates another embodiment of an inner sleeve 308 according to the present invention. The inner sleeve 308 is similar to the prior two embodiments with two exceptions. First, the inner sleeve 308 does not have a sleeve slot, but does have a larger central opening 332 to allow for an easier insertion of the optical fibers of the optical fiber ribbon 102 and the ferrule 20 into the inner sleeve 308. Second, the guide pin holes 390,392 are not separate openings through the inner sleeve 308 but they are in communication with the central opening 332 (i.e., interfere with the central opening 332).

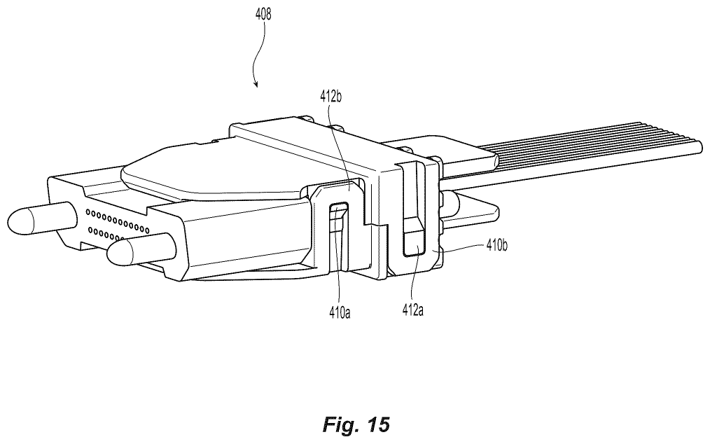

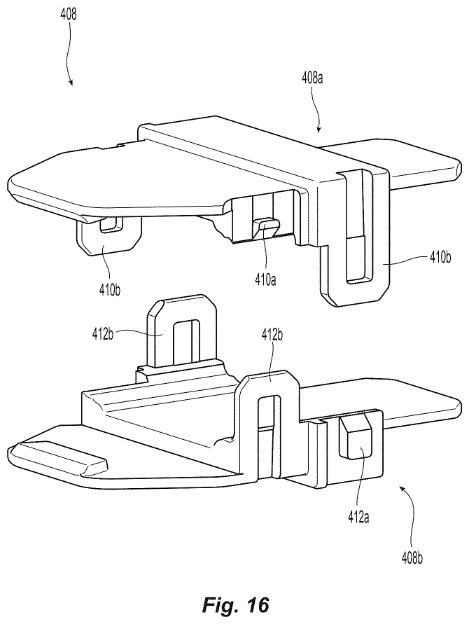

FIGS. 15 and 16 illustrate another embodiment of an inner sleeve 408 according to the present invention. In this embodiment, the inner sleeve 408 is made up of two portions 408a and 408b, generally corresponding to a top portion 408a and a bottom portion 408b. In this embodiment, there is no need for a sleeve slot since the optical fibers of the optical fiber ribbon 102 can be disposed within one of the portions and the other portion can then be attached to the first portion, capturing the ferrule 20 and the optical fibers of the optical fiber ribbon 102. On each of the portions 408a,408b are latches and receptacles to secure the portions 408a,408b to one another. With reference to FIG. 16, the top portion 408a has a latch or projection 410a and a receptacle 410b on each side thereof. The bottom portion 408b has a latch or projection 412a and a receptacle 412b on each side thereof. It is a simple snap-fit of the portions 408a,408b. The remainder of the elements of the portions 408a,408b are the same or similar to those illustrated and described with reference to inner sleeves 108, 208 and 308.

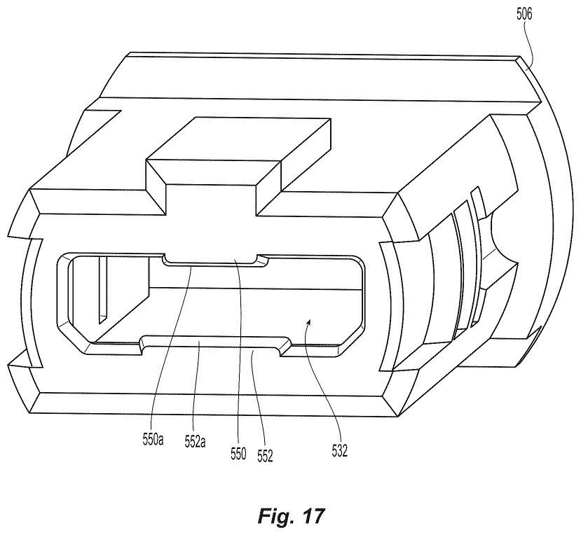

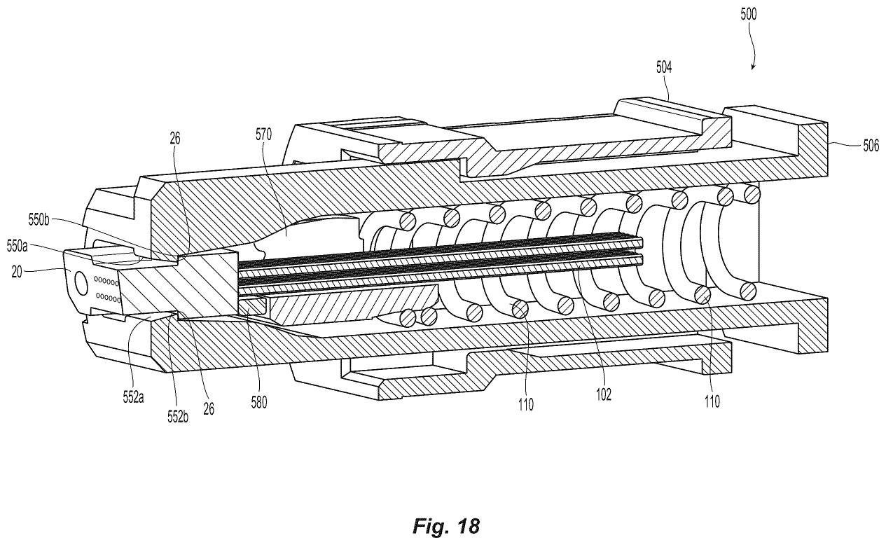

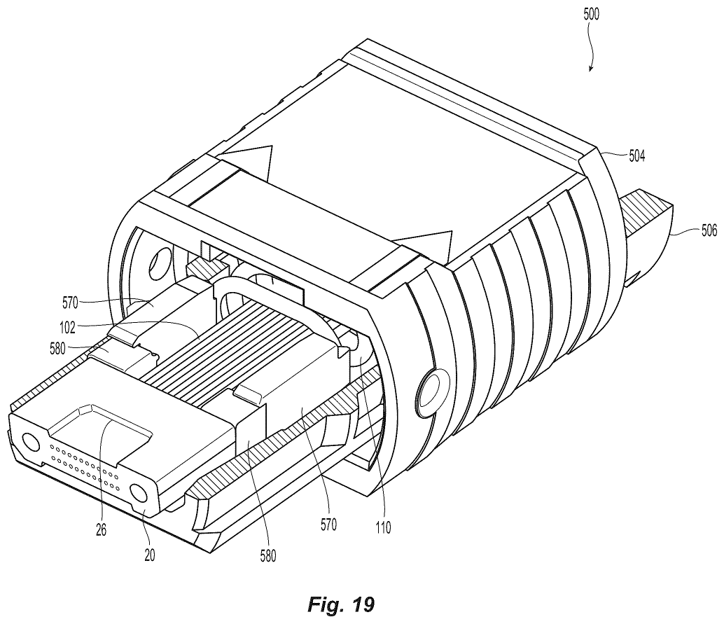

Another embodiment of a connector 500 is illustrated in FIGS. 17-19. The connector 500 has an outer housing 504 and an inner housing 506. The connector 500 may also include a spring 110, a pin clamp 580 or a pin clamp substitute (for female configurations), and a centering element 570 for the spring 110. It will be appreciated by one of ordinary skill in the art after reading this disclosure that the centering element 570 is behind the pin clamp 580, which is a departure from standard practice with MPO pin clamps. In this embodiment, the inner housing 506 has the structure in the central opening 532 that was present on the inner sleeves in the prior embodiments to engage the ferrule 20. That is, the inner housing 506 has a rearward facing surface 550b and a rearward facing surface 552b on projections 550 and 552, respectively, to engage the forward facing surface 26 on the ferrule 20 to assist in keeping the ferrule 20 within the inner housing 506 and the connector 500. While this reduces the component count (by not requiring a sleeve), it also makes the inner housing 506 non-standard for MPO connectors, at least for a front section of the inner housing 506.

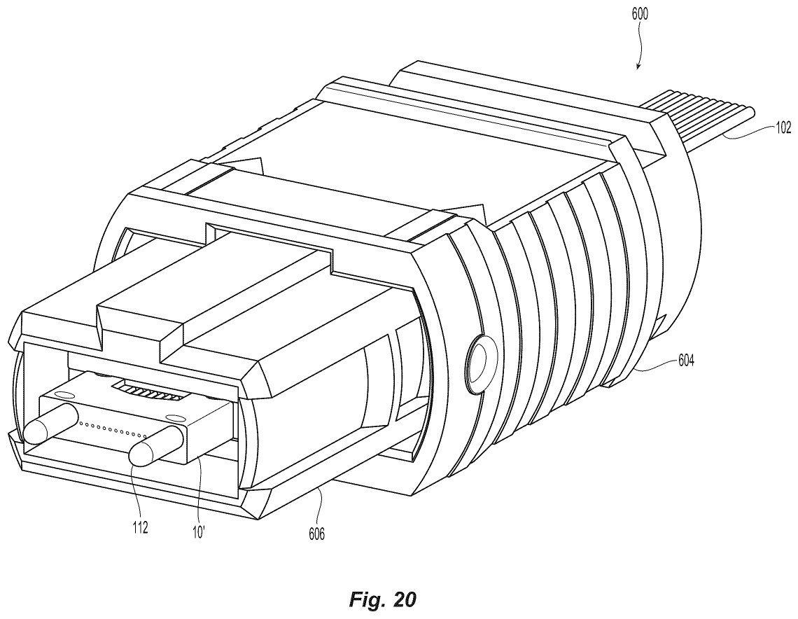

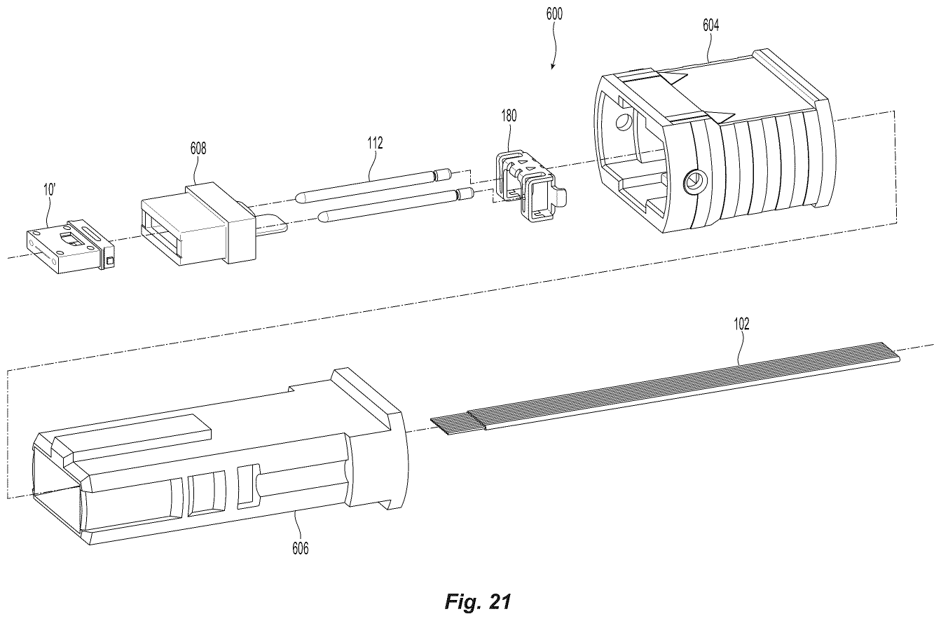

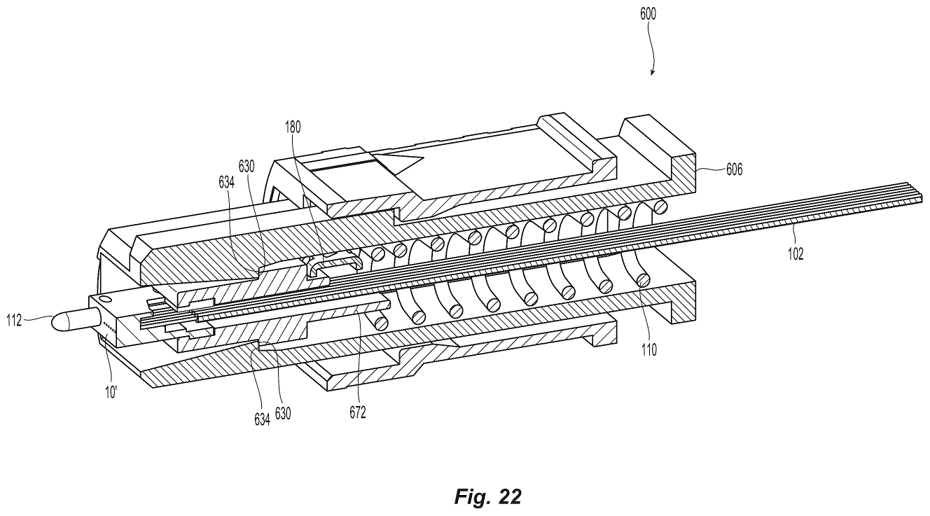

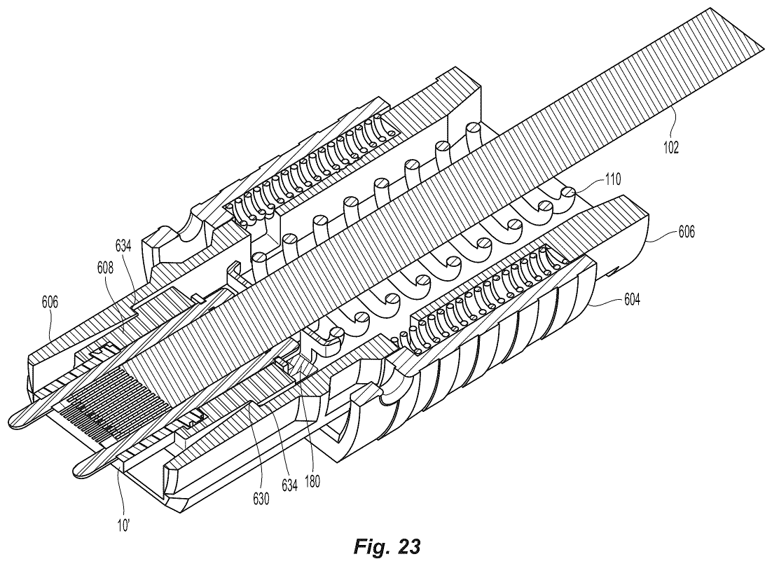

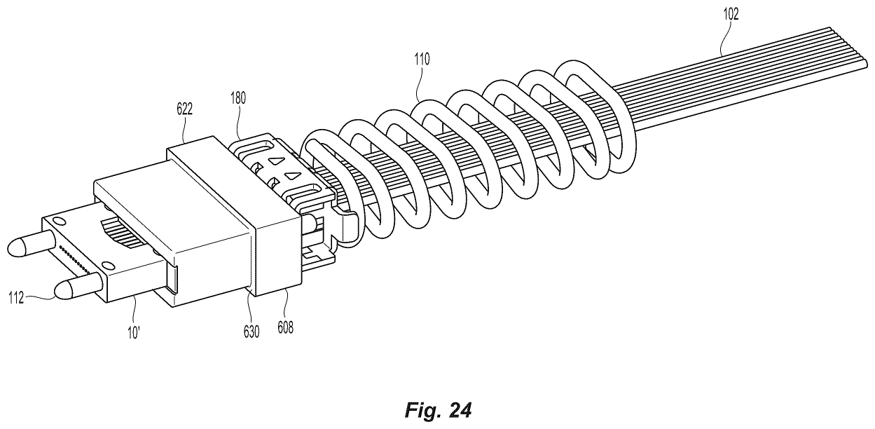

Another embodiment of a multi-fiber connector 600 is illustrated in FIGS. 20-26. In this embodiment, an inner sleeve 608 has been modified to receive an non-MT ferrule, such as ferrule 10′ and still be used with a conventional inner housing 606 and outer housing 604 for an MT-ferrule 10. The non-MT ferrule 10′, as illustrated has shoulders, unlike the ferrule 20 that does not. The non-MT ferrule as used herein refers to any ferrule that does not fit the description of the MT ferrule 10 above (3.0 mm height, 8.05 mm length between the front end and the rear end, and 7 mm width). With reference to FIG. 21, the connector 600 has the ferrule 10′, the inner sleeve 608, guide pins 112 (although they are not required), the pin clamp 180, the outer housing 604, the inner housing 606 and the optical fibers 102. The inner housing 606 has a rear facing surface 634 inside the inner housing 606. The rear facing surface 634 engages a sleeve shoulder 630 on the inner sleeve 608. See FIGS. 22-26.

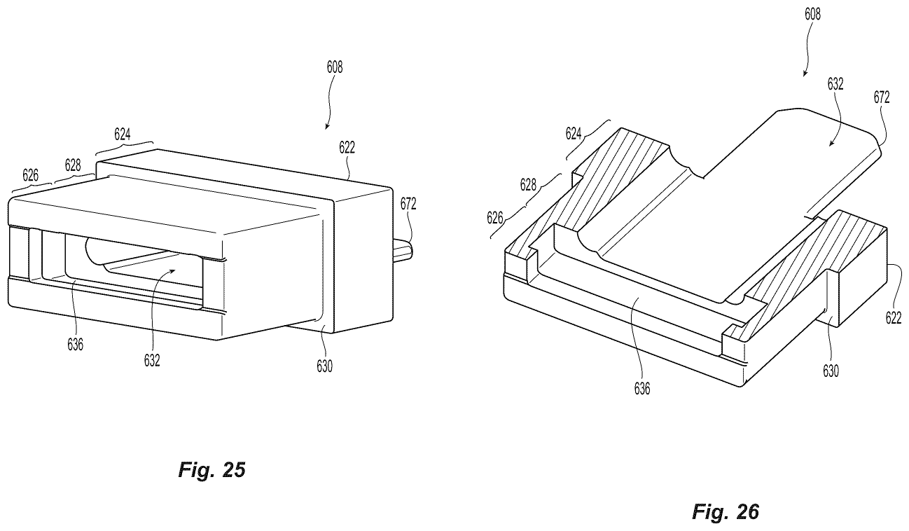

The inner sleeve 608 has a rear portion 624, a front portion 626 and a middle portion 628 (see, FIG. 26). Between the rear portion 624 and the shoulder 622 in particular and the middle portion 628 is the sleeve shoulder 630 that is configured to engage the rear facing surface 634 inside the inner housing 606. The front portion 626 has a cavity 636 that is configured to receive the shoulder 12 of the ferrule 10′. See also, FIG. 25. The shoulder 12 of the ferrule 10′ disposed within the cavity 636 causes the ferrule 10′ to move with the inner sleeve due to the interaction of the shoulder 12 with the front and rear facing surfaces of the cavity 636. The inner sleeve 608 also has a centering element 672 for the spring 110.

The inner sleeve 608 may be a singular element or it could be comprised of two different pieces that are combined to be a unitary piece. That is two pieces could be glued, welded or subjected to another process and still fall within the scope of the present invention.

A sleeve for holding a non-MT multi-fiber ferrule is provided, the sleeve includes a main body having a front portion, a middle portion and a rear portion, a central opening extending longitudinally between a rear end of the rear portion to a front end of the middle portion, the central opening configured to receive at least one optical fiber ribbon, a cavity in the front portion forward of the central opening and in continuum thereof, the cavity at least partially surrounded by a rear facing wall at a front end of the cavity and defining an additional front opening at the front end of the inner sleeve, the rear facing wall configured to engage a non-MT multi-fiber ferrule, a sleeve shoulder formed between the rear portion and the middle portion to engage an inner housing of an MPO fiber optic connector, and at least one centering element to support a spring to bias the sleeve in a forward direction inside the inner housing. The main body of the sleeve has at the rear end of the rear portion, at least one receptacle to receive at least one projection from a pin clamp disposed behind the multi-fiber fiber optic ferrule.

In this respect, the invention is also directed to a combination of the sleeve and the non-MT ferrule together. The combination may stay inside, for example, a pulling grip of a fiber optic cable bundle. The pulling grip by itself is known to one of ordinary skill in the art.

An MPO connector having a non-MT multi-fiber ferrule that includes an outer housing, an inner housing at least partially within the outer housing, an inner sleeve having a main body and a sleeve shoulder at a rear portion of the main body, the inner sleeve at least partially positioned within the inner housing and engaged to a sleeve seat inside the inner housing, a non-MT multi-fiber ferrule having optical fiber support structures to hold optical fibers of at least one fiber-optic ribbon, the non-MT multi-fiber ferrule held by the inner sleeve at a ferrule shoulder of the non-MT multi-fiber ferrule, and an MPO spring positioned rearward of and engaged to a rear end of the inner sleeve to bias a combination of the non-MT multi-fiber ferrule and the inner sleeve in a forward direction. wherein the combination of the inner sleeve and the non-MT multi-fiber ferrule is in a floating configuration inside the MPO fiber-optic connector.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A multi-fiber fiber optic connector for a multi-fiber fiber optic ferrule having at least one terminated row of optical fibers comprising:
an outer housing;
an inner housing at least partially disposed within the outer housing;
an inner sleeve having a main body and a shoulder at a rear portion of the main body, the inner sleeve at least partially positioned within the inner housing and engageable with a rear facing surface inside the inner housing and having a central opening;
the multi-fiber fiber optic ferrule having optical fiber support structures to hold optical fibers of the at least one terminated row of optical fibers, the multi-fiber fiber optic ferrule engaged by a rearward facing surface of the inner sleeve; and
a spring positioned rearward of and exerting a force on a rear end of the inner sleeve to bias the multi-fiber fiber optic ferrule and the inner sleeve in a forward direction,
wherein the combination of the inner sleeve and the multi-fiber fiber optic ferrule is in a floating configuration inside the multi-fiber fiber optic connector.

2. The multi-fiber fiber optic connector according to claim 1, wherein the multi-fiber fiber optic connector is an MPO connector and the multi-fiber fiber optic ferrule is a TMT ferrule.

3. The multi-fiber fiber optic connector according to claim 1, further comprising a sleeve shoulder formed on the main body to engage an inner housing of the multi-fiber fiber optic connector.

4. The multi-fiber fiber optic connector according to claim 3, wherein the sleeve shoulder is disposed between the rear portion and the middle portion.

5. The multi-fiber fiber optic connector according to claim 1, further comprising at least one centering element to support a spring to bias the inner sleeve in a forward direction toward the multi-fiber fiber optic ferrule.

6. The multi-fiber fiber optic connector according to claim 1, further comprising a pin clamp disposed between the multi-fiber fiber optic ferrule and the spring.

7. The multi-fiber fiber optic connector according to claim 1, further comprising a sleeve slot formed on one side of the main body extending longitudinally between the rear portion and the middle portion to allow the insertion of optical fibers into the central opening.

8. The multi-fiber fiber optic connector according to claim 1, wherein the at least one centering element comprises two centering elements, the two centering elements disposed on opposite sides of a central opening in the main body.

9. The multi-fiber fiber optic connector according to claim 1, wherein the inner sleeve further comprises a top extension and a bottom extension in a front portion of the main body and extending away from both a middle portion and the rear portion, each of the top extension and the bottom extension having a rear facing surface at a free end to engage the multi-fiber fiber optic ferrule.

10. A sleeve for receiving a multi-fiber fiber optic ferrule, the sleeve comprising:
a main body having a front portion, a middle portion, and a rear portion;
a top extension and a bottom extension in the front portion and extending away from both the middle portion and the rear portion, each of the top extension and the bottom extension having a rear facing surface at a free end to engage the multi-fiber fiber optic ferrule;
a central opening extending longitudinally between a rear end of the rear portion and a front end of the middle portion and being in communication with a space between the top extension and the bottom extension, the central opening configured to receive at least two optical fibers;
a pair of guide pin bores on opposing sides of the central opening and also extending longitudinally between the rear end of the rear portion to the front end of the middle portion;
a sleeve shoulder formed on the main body to engage an inner housing of a multi-fiber fiber optic connector; and
wherein the middle portion includes at least one ferrule seat between the top extension and the bottom extension adjacent the central opening to seat the multi-fiber fiber optic ferrule.

11. The sleeve according to claim 10, wherein the rear portion of the sleeve has a rear-facing rear end enclosing an area same as that of a rear facing rear of an MT ferrule.

12. The sleeve according to claim 10, wherein the sleeve shoulder is disposed between the rear portion and the middle portion.

13. The sleeve according to claim 10, further comprising at least one centering element to support a spring to bias the sleeve in a forward direction toward the multi-fiber fiber optic ferrule.

14. The sleeve according to claim 10, further comprising a sleeve slot formed on one side of the main body extending longitudinally between the rear portion and the middle portion to allow the insertion of the at least two optical fibers into the central opening.

15. The sleeve according to claim 13, wherein the at least one centering element comprises two centering elements, the two centering elements disposed on opposite sides of the central opening.
